(19) United States
(12) Patent Application Publication
(10) Pub. No.: US 2013/0163808 A1
(43) Pub. Date: Jun. 27, 2013

(54) Method and System of Digital Steganography

(71) Applicants: Mark Gregory Clements, Manchester, NH (US); Calvin Lester Ellis, Manchester, NH (US)

(72) Inventors: Mark Gregory Clements, Manchester, NH (US); Calvin Lester Ellis, Manchester, NH (US)

(21) Appl. No.: 13/426,064

(22) Filed: Mar. 21, 2012

Related U.S. Application Data
(60) Provisional application No. 61/578,399, filed on Dec. 21, 2011.

(51) Int. Cl. G06K 9/00

(52) U.S. Cl. 382/100

(57) ABSTRACT

The system and method of digital steganography comprises a sending AI engine, a decision tree AI engine, an armored security object, and a receiving AI engine. The armored security object comprises concentric layers. The layers of the armored security object can be 3-dimensional and are comprised of at least one axis of rotation, at least one surface, at least one color, and at least one texture.

### CROSS REFERENCE TO RELATED APPLICATIONS

This Application claims the benefit of U.S. Provisional Application No. 61/578,399, filed Dec. 21, 2011, the contents of which are incorporated by reference herein in their entirety.

### FIELD OF THE INVENTION

The present invention relates to data security measures, and more particularly to the field of digital steganography. The system and method use multiple artificial intelligence engines to lock and unlock armored security objects.

### BACKGROUND OF THE INVENTION

Transport Layer Security (“TLS”) and its predecessor, Secure Sockets Layer (“SSL”), are cryptographic protocols that provide communication security over the Internet. TLS and SSL encrypt the segments of network connections above the Transport Layer, using asymmetric cryptography for key exchange, symmetric encryption for privacy, and message authentication codes for message integrity.

Current data security methods include TLS 1.0, SSL 2.0 and SSL 3.0. From a security standpoint, SSL 3.0 should be considered to be less desirable than TLS 1.0. The SSL 3.0 cipher suites have a weaker key derivation process; half of the master key that is established is fully dependent on the MD5 hash function, which is not resistant to collisions and is, therefore, not considered secure.

MD5 digests have been widely used in the software world to provide some assurance that a transferred file has arrived intact. For example, file servers often provide a pre-computed MD5 checksum for the files, so that a user can compare the checksum of the downloaded file to it. However, now that it is easy to generate MD5 collisions, it is possible for someone who created a file to create a second file with the same checksum, thus enabling some forms of malicious tampering to remain undetected.

Under TLS 1.0, the master key that is established depends on both MD5 and SHA-1 (Secure Hash Algorithm-1), so its derivation process is not currently considered weak. SSL 2.0 is disabled, by default, in many browsers, including Internet Explorer 7, Mozilla Firefox 2, Mozilla Firefox 3, Mozilla Firefox 4, Opera, and Safari. For example, after a TLS Client Hello is sent, if Mozilla Firefox finds that the server is unable to complete the handshake, it will attempt to fall back to using SSL 10, with an SSL 3.0 Client Hello in SSL 2.0 format, to maximize the likelihood of successfully handshaking with older servers. Support for SSL 2.0 (and weak 40-bit and 56-bit ciphers) has now been removed completely from Opera, as of version 9.5.

Given the limitations of current Internet and computer security and encryption methods, new methodologies must be defined. Security vulnerabilities in TLS 1.0, SSL 2.0 and SSL 3.0 impede trust in the security methods used to handle our data and thus our ability to move forward with E-commerce and confidential transactions over the Internet. These weaknesses also prevent browser manufacturers from committing to an effective security standard which could close additional security loopholes.

Based on a unique inside-out approach for key generation that incorporates one time use access strings, provides enhancement to or replacement of current security and encryption solutions, the method and system of the present invention enable scaling access string combinations by magnitudes. Our starting point for the development of digital steganographic encryption methods is that the security of the method is based on AI engines as a replacement for the generated encryption keys used currently, and that the secrecy and/or publicity of the method itself does not affect the security of the mechanism.

One of the many advantages of steganography, over cryptography alone, is that messages do not attract attention to themselves. Where cryptography protects the contents of a message, steganography can be said to protect both messages and communicating parties.

### SUMMARY OF THE INVENTION

It has been recognized that present data security methods “look at” the data from the outside-in. The artificial intelligence (“AI”) engines of the present invention, in conjunction with the digital steganographic armoring of data, allow security methods to be approached in such a way that the data is “looked at” from the inside-out. Thus, until the receiving AI Engine can be checked against the “expectations” of the decision tree AI engine, the armor around the digital steganographic data will not be unlocked (de-armored). If what is expected of the receiving AI engine is not correct, the decision tree AI engine will not de-armor the data or message, and the presence of a steganographically encrypted message will go undetected.

One aspect of the present invention is a system comprising a method of digital steganography comprising the steps of: providing a sending AI engine, wherein the sending AI engine is capable of being authenticated; providing a receiving AI engine, wherein the receiving AI engine is capable of being authenticated; initializing the sending AI engine upon authentication of a sender of data; creating an initial armored security object containing data to be transferred securely, wherein the initial armored security object is created by the sending engine; creating a decision tree AI engine, wherein the decision tree AI engine is created by the sending AI engine; creating a final armored security object, wherein the final armored security object is created by the decision tree AI engine; and comparing information received from a receiving AI engine with data known to represent the authenticated receiving AI engine to determine whether or not the data to be transferred securely should be unlocked, wherein the step of comparing information is conducted by the decision tree AI engine.

In one embodiment, the method of digital steganography further comprises the step of notifying the sending AI engine that the data to be transferred securely was not rejected. In one embodiment, the method of digital steganography further comprises the step of notifying the sending AI engine that the data to be transferred securely was rejected.

In one embodiment, the method of digital steganography further comprises the step of forming a returning AI engine, wherein the returning AI engine is formed from the decision tree AI engine. One embodiment of the method of digital steganography wherein the returning AI engine comprises a self-destruct routine. One embodiment of the method of digital steganography wherein the sending AI engine comprises a self-destruct routine.

One embodiment of the method of digital steganography wherein the initial armored security object is created after a threat assessment by the sending AI engine. One embodiment of the method of digital steganography wherein the final armored security object is created after a threat assessment by the decision tree AI engine.

One embodiment of the method of digital steganography wherein the initial armored security object comprises a plurality of concentric layers. One embodiment of the method of digital steganography wherein the final armored security object comprises a plurality of concentric layers, including at least one black outer layer.

One embodiment of the method of digital steganography wherein the plurality of concentric layers of the armored security object are each 3-dimensional. One embodiment of the method of digital steganography wherein each of the concentric layers of the armored security object is the same shape. One embodiment of the method of digital steganography wherein each of the concentric layers of the armored security object has at least one axis of rotation. One embodiment of the method of digital steganography wherein each of the concentric layers of the armored security object has at least one surface.

One embodiment of the method of digital steganography further comprising the step of unlocking the armored security object. One embodiment of the method of digital steganography wherein the armored security object is unlocked by the decision tree AI engine.

One embodiment of the method of digital steganography wherein step of unlocking the armored security object comprises manipulating each concentric layer of the armored security object in sequence from the outermost layer to the inner most layer. One embodiment of the method of digital steganography wherein the manipulation of each concentric layer comprises axis rotation, axis tilt, analysis of color, and analysis of texture.

Another aspect of the present invention is a system of digital steganography comprising, a sending AI engine; a decision tree AI engine; an armored security object; and a receiving AI engine.

One embodiment of the system of digital steganography wherein the armored security object comprises a plurality of concentric layers. One embodiment of the system of digital steganography wherein the plurality of concentric layers are 3-dimensional. One embodiment of the system of digital steganography wherein each of the concentric layers is the same shape. One embodiment of the system of digital steganography wherein each of the concentric layers has at least one axis of rotation.

One embodiment of the system of digital steganography wherein each of the concentric layers is comprised of at least one surface. One embodiment of the system of digital steganography wherein the at least one surface is comprised of a plurality of pixels. One embodiment of the system of digital steganography wherein the at least one surface is comprised of at least one texture. One embodiment of the system of steganography wherein each pixel comprises a color.

Another aspect of the present invention is an armored security object comprising a plurality of concentric layers. One embodiment of the armored security object wherein the plurality of concentric layers are 3-dimensional. One embodiment of the armored security object wherein each of the concentric layers is the same shape. One embodiment of the armored security object wherein each of the concentric layers has at least one axis of rotation.

One embodiment of the armored security object wherein each of the concentric layers is comprised of at least one surface. One embodiment of the armored security object wherein the at least one surface is comprised of a plurality of pixels. One embodiment of the armored security object wherein the at least one surface is comprised of at least one texture. One embodiment of the armored security object wherein each pixel comprises a color.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of an embodiment of a system of the present invention.

FIG. 2 is a diagram of an embodiment of an armored security object of the present invention.

FIG. 3 is a flow chart of an embodiment of a method of the present invention.

### DETAILED DESCRIPTION OF THE INVENTION

Steganography is the science of hiding messages in such a way that no one, apart from the sender and the intended recipient, is aware of the existence of the hidden message. This form of security is different from cryptography which hides the contents of a message, but where the message itself is not hidden. Generally, in steganography, messages appear hidden in some other object, including visual images, literature or other printed material, handwritings, or some other decoy communication. Originally, steganography consisted of hiding messages in invisible ink in between the lines of a private letter.

Steganography can include the concealment of information within computer files. This form of steganography is commonly referred to as digital steganography. The electronic communications may include coding inside a document file, an image file, a program, or a protocol. Media files work well due to their large size, where additional information is not as easily detected. One common example would be to start with an image file and change the color of every n^{th} pixel to create a change in the image that is so subtle that unless someone was looking for it they would be unlikely to note the change.

An AI engine is a program that accepts data and analyzes it for use in determining what steps, if any, it should perform. The engine is said to be intelligent because it effectively “reasons,” based on the data it receives, as to the most appropriate action to take within a defined set of possibilities. It should be understood that the tasks performed by one or more AI engines of the present invention may be performed by one or more AI engine-like process(es).

Some AI engines of the present invention include the following examples. The decision tree AI engine is an AI engine that is tasked with responsibility for Reject, or Fail to Reject, along with other associated tasks. The receiving AI engine is an AI engine expected to receive the data or message. The returning AI engine is an AI engine tasked with returning the armored enhanced security object, after a Reject by the decision tree AI engine. The satellite AI engines are spawned AI engines, which are able to house multiple layers of steganographic carrier, surrounding the payload. The sending AI engine is an AI engine tasked with final delivery of the armored enhanced security object, after a Fail to Reject, by the decision tree AI engine.

AI layers are layers of both interactive and non-interactive AI engines.

Carriers comprise various stages of digital steganographic files, satellite AI engines, along with other related data that both armor (shield) and “carry” the payload through the transport layer. Channels are a type of file that holds the payload (such as .gif, .jpg, etc.).

Data transport of the present invention is done through Layer #4 of 7 of the OSI Model. This transports the payload and the AI enhanced carrier to what is to be evaluated as the receiving destination.

Armored data is a combination of payload, plus the enhanced carrier, which includes the stego channel, AI engines, and related data. Unarmored data is the same as payload (e.g. the data or message to be sent/received).

Unlock sequences can be based upon a multitude of factors, among them: radians or degrees (where degrees could be stated as degrees with decimals only, degrees with decimal minutes, or degrees and minutes—with decimal seconds, and the like). Unlock sequences and other data can be transmitted by text or with non-text encoding. QR codes, or other encoding means, could be utilized so that textual data would not have to be transmitted, and thus would not be exposed. There are many mathematical techniques or methodologies which could be used in the digital steganographic encryption of data of the present invention. Some include Helmert Transformations, Gauss-Kruger coordinates, rotational matrices, infinitesimal rotations of matrices, matrix decompositions, Euclidean and Non-Euclidean geometry, inductive, spatial and temporal dimensions, hyperspheres, platonic solids, along with combinatorial mathematics, hypercubes and orthographic projections, multi-factorials, hyper-factorials, and sub-factorials, and the like. Additionally, dual polyhedra and tessellations, as well as the use of mirror or reflective properties, or shadow properties, planar and hyperplane systems, and the like can all be used in the digital steganographic encryption of data.

Payload is the data and/or message(s) to be sent/received.

Reject is when the decision tree AI engine chooses to select (believe) that the proposed receiving AI engine isn't the one that was previously acknowledged. In contrast, Fail to Reject is when the decision tree AI engine hasn't rejected that the proposed receiving AI engine is the same as the previously acknowledged receiving AI engine. This might also be noted as a “success.” An analogy would be similar to the use of “guilty” vs. “not guilty.” The statement of “not guilty” doesn't mean the same as “innocent,” but is more akin to a situation where there wasn't enough evidence to “convict” or “reject.”

A security object is the combination of the payload and carrier, in which the carrier might or might not be “armored” at a given point in time. Steganographic basically means “concealed writing.” The present invention uses digital steganography as a way to provide an AI enhanced version of what might typically be referred to in terms of “encryption.”

A stego file package typically is the combination of the payload and the channel, and is called the Stego File or the Package. Here, because of the multiple layers, we refer to this as a stego file package (packaged group of stego files). An enhanced stego file package comprises the satellite AI engines, in conjunction with the stego file package. The stego file package, enhanced with AI, comprises an enhanced stego file package, after the decision tree AI engine has been introduced.

A sending AI engine is an AI engine responsible for receiving information regarding the intended recipients, and later receiving data regarding whether there has been a rejection of the data or message, or a failure to reject the data or message (a successful delivery). The sending AI engine is also responsible for creating the initial armored security object. The sending AI engine is also responsible for creating a series of satellite AI engines, the last of which is called the decision tree AI engine. The AI engines are created, in part, based on an initial threat assessment. Another unique feature is that the unlock sequence is a unique (e.g. used only once) sequence. Further, the sending AI engine will not only never repeat the unlock sequence used; it will not follow what appears to be known or theoretically predictable patterns.

A decision tree AI engine is an AI engine created by the sending AI engine. Based on inputs from the sending AI engine, the decision tree AI engine is tasked with surveying the system and determining the threat level; along with the corresponding unlock sequences and layers for a particular message, or other piece of data. For example, a message may be highly classified and thus warrant the highest possible levels of obfuscation, or a message may require “normal” security levels, but it might be traveling over wireless communications which would amplify the need for more rigorous obfuscation techniques. The decision tree AI engine will weigh system and message requirements and balance those against other factors to determine the extent of obfuscation needed in each particular instance.

Factors that might pose the need for further obfuscation include, but are not limited to: (1) already defined security settings for the sender and/or receiver; (2) whether transmission goes through any type of wireless or holographic device; and (3) the sender's subjective estimate as to how much the data needs to be protected (e.g. if banking, medical, law enforcement, or military related data is to be transmitted, there will be more advanced obfuscation involved than say, e-mails sent to a family member).

Once the threat has been assessed, the decision tree AI engine will add at least one additional layer to the initial armored security object in keeping with the level of obfuscation security required. Next, the decision tree AI engine will receive data from the receiving AI engine and attempt to match the incoming data with the data the decision tree AI engine “expects” to receive. If there is a match, then the decision tree AI engine will initiate the unlocking process for the armored security object from the outside layers in to the inner most layer. The decision tree AI engine will also send a message back to the sending AI engine to notify of the “failure to reject” or successful delivery of the message or data. The decision tree AI engine is also responsible for turning over the data to the receiving AI engine at the appropriate time.

If the decision tree AI engine does not detect a match between the receiving AI engine and what it “expects” to receive, the decision tree AI engine will send a message back to the sending AI engine alerting it of the rejection of the data or message along with the return of the armored security object containing the undelivered, undetected message. The “reject” process will morph and/or change the outermost layers of the armored security object. The process, by which the fully armored data will make the return trip back to the sending AI engine, includes changing the state of the decision tree AI engine, to create a returning AI engine, such that the returning AI engine has directions to return the message to the sender—only to the sender—and absolutely nowhere else. In another embodiment, the returning AI engine can include a predominant self-destruct routine. This would include a digital shredding and sanitizing process, which would shred and sanitize, from the inside-out. This is done to protect the sanctity of the data. The images, steganographically encrypted data, coloration, elevation perceptions; even the AI engines (from the inside-out), would be destroyed. The outermost of the at least one “black” layers would be retained and returned to the sending AI engine via the returning AI engine, along with a summary log file of what transpired, so that the sender has an idea of what might have caused the data to not be received and unlocked by the intended receiving AI engine.

In another embodiment, if the returning AI engine does not have the ability to predominantly self-destruct, a self-destruct routine will be run by the sending AI engine, upon the rejection notice appearing for the sender. Regardless, the sending AI engine is tasked with the destruction of the data that was sent, along with any and all engines and routines that evolved thereto. The returned, self-destruct process will also create a summary log of what transpired, so that the sender has an idea of what might have caused the data to not be received and unlocked by the intended receiving AI engine. Further, the sending AI engine will ensure the destruction of any and all unlock information, at any and all AI engine (including satellite) levels upon receiving the Reject information from the returning AI engine.

The sending AI Engine, based upon threat and other factors, gets to make the decision about whether or not the steganographically armored data will be destroyed, to prevent likelihood of potential compromise, or if the destruction duties will be performed by the sending AI engine, upon successful return of the armored security object and the various satellite AI engines (including the decision tree AI engine) to the sending AI engine. Either way, what ultimately takes place is “decided by” the sending AI engine. No matter when the destruction of data is to take place (in the event of a Rejection), the steganographically encrypted data is destroyed from the inner-layers, outwards. This is done to protect the sanctity of the data. Both the original data that was to be armored, along with the steganographic file portions, are destroyed as a single unit, to disallow the possibility of the data being segregated, and therefore potentially compromised, by possible exploits of external programs or other externalities of the patented designed system.

A receiving AI engine is an AI engine that receives an initial request for information regarding its properties for use in communicating with a potential sender of a steganographic data or message. The receiving AI engine also must decide to send such information to a decision tree AI engine, which requests a description of its properties. If the decision tree AI engine determines that there is a match, as described above, the receiving AI engine is responsible for receiving the unlocked, unarmored data or message from the sender, and reporting that back to the decision tree AI engine so that the decision tree AI engine can notify the sender of the failure to reject (e.g. successful delivery) of the desired data or message. Part of this could be processed using one or more of an entity's file servers, including saving content information onto one or more entity file servers.

There are several forms of authentication known to one of ordinary skill in the art. In the case of a sender or a receiver of information, authentication is used to verify that the person either sending or receiving the information is in fact who they say they are. The ways in which someone may be authenticated fall into three main categories, or factors of authentication. The first authentication factor is known as a knowledge factor. A knowledge factor is something the person knows, such as a password, pass phrase, personal identification number (PIN), or even a challenge response where the user must answer a personal question. The second authentication factor is known as an ownership factor. An ownership factor is something the user has, such as a wrist band, ID card, security token, software token, or even a cell phone. The third authentication factor is known as an inherence factor. An inherence factor is something the user is or does, such as a fingerprint, retinal pattern, DNA sequence, signature, face, voice, unique bio-electric signal, or some other biometric identifier.

Each authentication factor covers a range of elements which are used to authenticate, or verify, a person's identity prior to their being granted access to information or a physical location. It is understood that for a positive identification, elements from at least two, and preferably all three, factors should be verified. Some examples of two-factor authentication include a bankcard (ownership) and a PIN (knowledge); a password (knowledge) and a pseudorandom number from a security token (ownership); and a fingerprint check (inherence) and a PIN and/or a day code (knowledge).

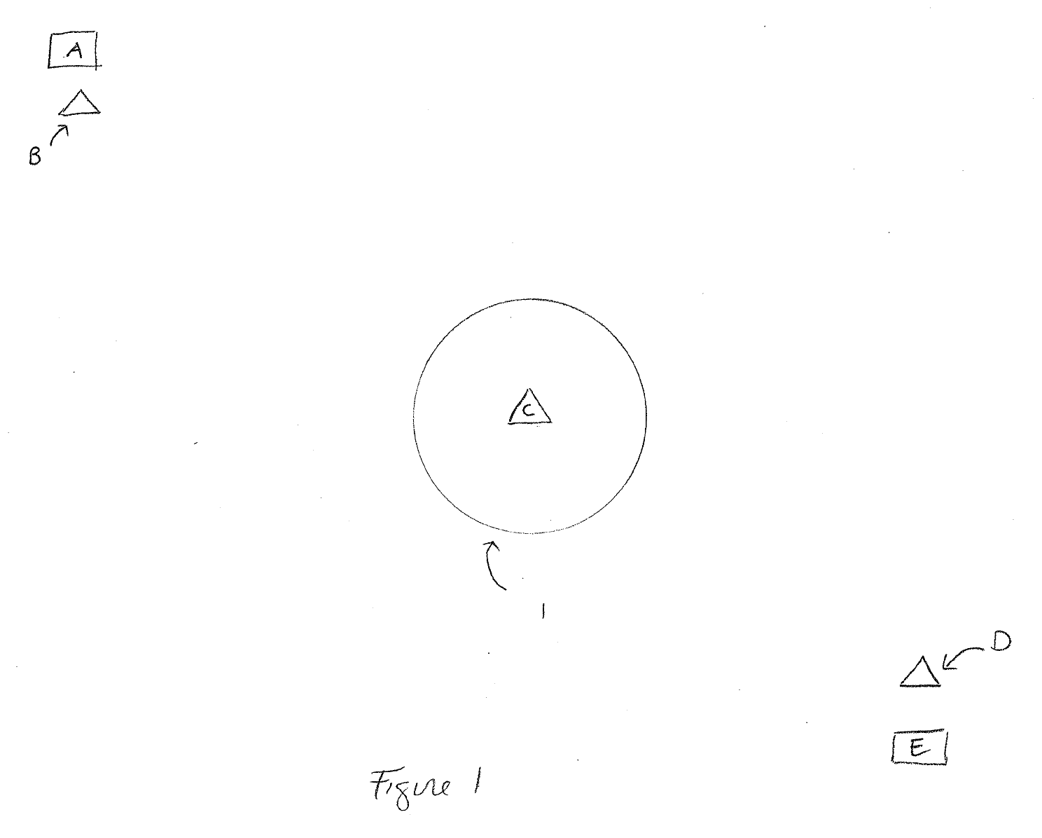

FIG. 1 shows one embodiment of a system of digital steganography of the present invention using at least one sending AI engine B, which receives input from an authentication source A, to signal initialization. Once initialized, the sending AI engine creates an initial armored security object 1 around the data to be transferred. The armored security object incorporates an obfuscated decision tree AI engine C, per armored object, which contains information relating to the sender, the receiver, and the particular information needed to unlock the armored security object once it arrives at its proper destination. The lock/unlock information and the sender/receiver information is all sent together with the armored security object, which contains the secure data or message distributed amongst the concentric layers of the armored security object. The decision tree AI engine then communicates with the receiving AI engine D to determine if it has been properly authenticated by E. If so, the decision tree AI engine communicates with the receiving AI engine to “unlock” the protected information. If not, the information remains obfuscated, and locked.

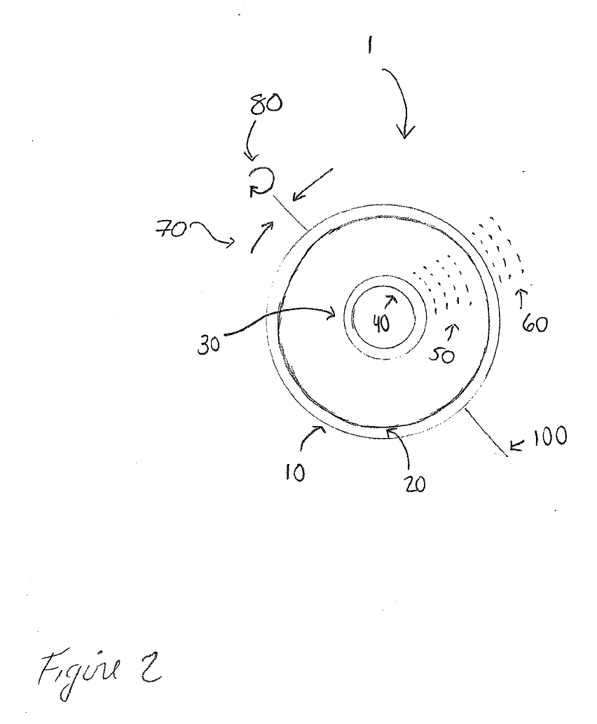

Referring to FIG. 2, the diagram represents one possible embodiment of an armored security object 1. As depicted, only some of the numerous layers are shown for simplicity. There may be additional internal or external layers, represented by 50 and 60, respectively. In FIG. 2, the armored security object is comprised of several concentric spheres 10, 20, 30, and 40. In practice, any number of different shapes could be use. The layers could be “smooth” or “faceted”. The layers could all be the same shape, as shown here as spheres; or they could each be different (e.g. a dodecahedron inside a sphere, inside a square pyramid, etc.). The outermost layers 10 and 20 can be black in order to help obscure the internal colored layers, which are used to create the steganographic image. Each layer will have at least one independent axis 100 that can be tilted in any direction (as shown by just two arrows 70, for simplicity), and the layer can also be rotated along its at least one axis 100 (as shown by a circular arrow 80). In addition to the spatial manipulations described for each layer, the concentric layers will each have independent surface qualities, such as textures, colors, etc.

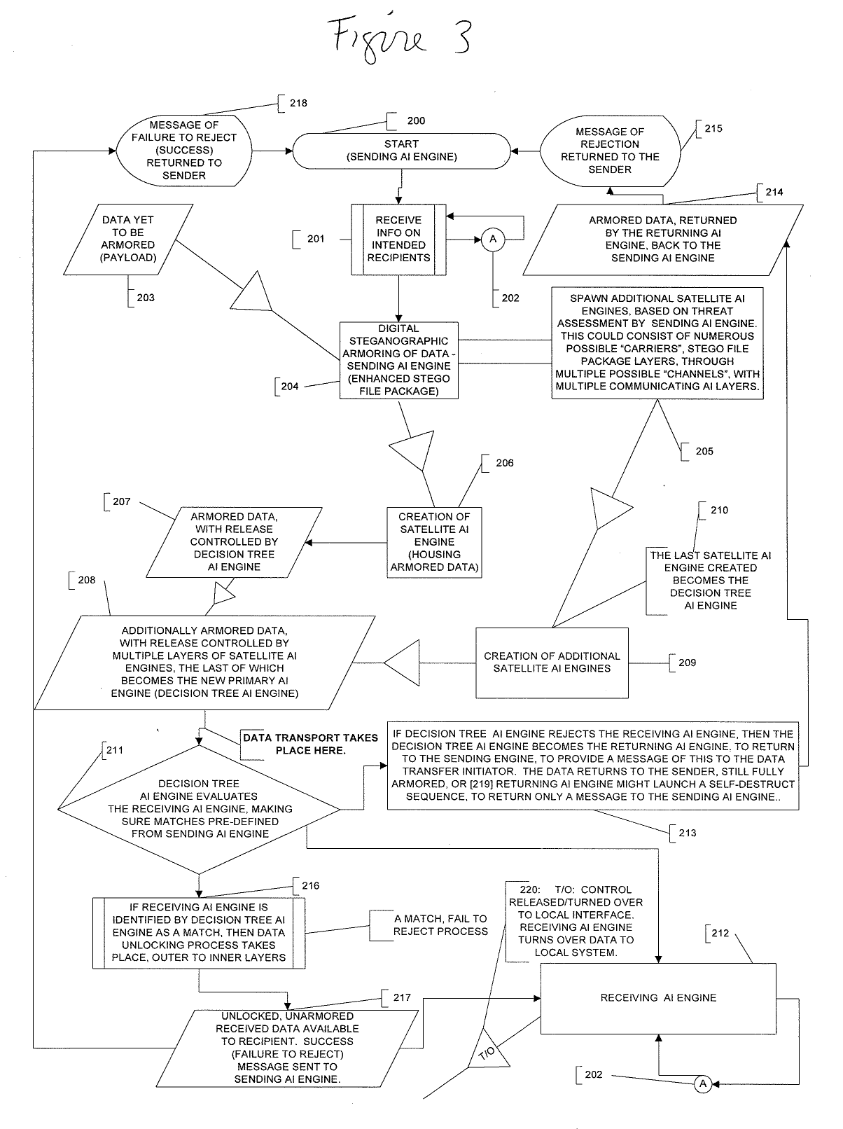

Referring to FIG. 3, the flow chart represents one embodiment of a method of the present invention. To begin, the system has a sending AI engine 200, which receives information about intended recipients 201 and also verifies authentication of the source of the information 202. After authentication has taken place, the sending AI engine initializes. This sending AI engine then creates a series of satellite AI engines based on an initial threat assessment (see 205, 206, 209 and 210). The sending AI engine also provides instructions to the various satellite AI engines and creates an initial armored security object, forming an enhanced stego file package. The final satellite AI engine created 210 becomes the decision tree AI engine responsible for controlling the release of the data held in the multiple layers of the armored security object 208, forming a stego file package, enhanced with AI. The decision tree AI engine then contacts the receiving AI engine and compares the data sent by the receiving AI engine; see 212 and 202, to see if the data received matches the data “expected” by the decision tree AI engine 211, based on information supplied by the sending AI engine 212.

If the decision tree AI engine rejects the receiving AI engine 213, then the decision tree AI engine returns a message to the sending AI engine of the rejection 215, along with the armored security object containing the steganographic data or message 214. The “reject” process morphs and/or changes the outermost layers of the armored security object such that the fully armored data makes the return trip back to the sending AI engine 214, including changing the state of the decision tree AI engine, to create a returning AI engine 213, such that the returning AI engine has directions to return the message to the sender—only to the sender—and absolutely nowhere else.

The returning AI engine may also include a predominant self-destruct routine, which includes a digital shredding and sanitizing process to shred and sanitize, from the inside-out. If the returning AI engine 213 does not have the ability to predominantly self-destruct, the self-destruct routine will be run by the sending AI engine, upon the rejection notice appearing for the sender (not shown). Regardless, the sending AI engine is tasked with the complete destruction of the data that was sent, along with any and all engines and routines that evolved thereto. In either case, a summary log file will accompany the returning AI engine along with the armored security object for complete destruction by the sending AI engine, even if the predominate self-destruct routine was run by the returning AI engine, and thus the armored security object being “returned” comprises the now unrecognizable, indecipherable data/message within an outermost at least one “black” layer.

Still referring to FIG. 3, if the decision tree AI engine detects a match 216 between the expected data from the receiving AI engine and the data actually received from the receiving AI engine, then the decision tree AI engine initializes the unlock process 217, and sends a message to the sending AI engine of a “failure to reject” 218, or successful delivery, of the desired data or message. The control of the data is then released, turned over, to the local interface 220, and the receiving AI engine then turns the data over to the local system.

Satellite AI engines are located within security object images, or armored security objects. The satellite AI engines are separate mini-programs that operate within the steganographic images. The satellite AI engines' role is to “un-scramble” the information, only after the correct coordinates/device identifiers, and/or biometric identification(s) have taken place. The instructions and the concealed data are sent together in the same data stream. The data to be concealed and transferred to a recipient is fragmented and hidden within the various layers of the armored security object, and the instructions dictate how to reassemble the fragments.

If the penultimate satellite AI engine, or decision tree AI engine, cannot locate a match between the sending and receiving instructions, then no axis spin, no rotations, no unlocking of the data contents, nor un-scrambling of the steganographic data contained therein will occur. Until the decision tree AI engine detects that the correct receiving AI engine has provided a match to what the decision tree AI engine was instructed to match, the data cannot be unlocked.

The sending and receiving AI engines can be present on an external drive, such as a USB thumb/flash drive, or internal to a computer. But, generally, the sending AI engine will not be controlled by the computer's motherboard. This allows for preserving and protecting the integrity of the sending AI engine, and preventing outside influences from disrupting the process by which the data is ultimately transformed into the appropriate armored security object.

An armored security object comprises a series of concentric shapes arranged in a layered, onion-type relationship. This could include various combinations, a few examples include: spheres within spheres, spheres with other multi-layered objects where the multi-layered objects could include a triangle or a rhombus, or other shaped series, inside of the sphere, with other shaped objects inside of these. Each object would have its own axes, with the ability to tilt, along with having a combination of positive and negative rotations available to each component layers' axes, within the overall security object.

The information to be protected is held within the various layers of the object, and is steganographic in nature. Color is used in the coordinates that make up each layer as one way to obfuscate the information being transferred. The range of colors available is very large (e.g. over 16.7 Million possibilities, covering HD, 3D, and Holographic applications), and the resolution for each individual color can be very small (e.g. one pixel).

One embodiment of the present invention may utilize shaders. Shaders are programs used to describe the traits of either a vertex or a pixel. Vertex shaders describe the traits (position, texture coordinates, colors, etc.) of a vertex, while pixel shaders describe the traits (color, z-depth and alpha value) of a pixel. There are three types of shaders in common use: pixel shaders, vertex shaders, and geometry shaders.

Pixel shaders, also known as fragment shaders, compute color and other attributes of each pixel. Pixel shaders range from always outputting the same color, to applying a lighting value, shadows, specular highlights, translucency and the like. Pixel shaders can also alter the depth of the pixel (for Z-buffering), or output more than one color if multiple render targets are active.

Vertex shaders are run once for each vertex. The purpose is to transform each vertex's 3D position in virtual space to the 2D coordinate at which it appears on the screen (as well as a depth value for the Z-buffer). Vertex shaders can manipulate properties such as position, color, and texture coordinates, but cannot create new vertices. The output from the vertex shader goes to the next stage in the pipeline, which may be a geometry shader, if present.

Geometry shaders are a relatively new type of shader. This type of shader can generate new graphics primitives, such as points, lines, triangles, and the like, from those primitives that were sent to the beginning of the graphics pipeline. Geometry shader programs are executed after vertex shaders. They take as input a whole primitive, possibly with adjacency information. For example, when operating on triangles, the three vertices are the input for the geometry shader. The shader can then emit zero or more primitives, which may be rasterized and their fragments passed on to a pixel shader.

Additionally, part of the manipulation of the rotation and tilt of each layer could include passing by a certain specific color coordinate, an unpredictable number of times, then tilting to a certain number of degrees away from the exact location along a particular axis, and then doing additional positive and/or negative spins. Successful completion of unlocking the outermost layer would then initialize the unlocking sequence for the next innermost layer and continue until all the layers have been unlocked. One can see the robustness of the method where each layer would have independent axes, providing additional tilt and rotational manipulations, as well as independent surfaces which could be broken down further into meshes, points, regions, etc. to provide an infinite number of unique layers used in the creation of unique armored security objects.

A minimum of one or more external black layers would encase the steganographic image layers to comprise an armored security object. Importantly, the inside plurality of layers could have coloration components, to serve as the “quality control” check for the algorithm's successful execution, as certain colors would be located at certain coordinates (not to be repeated among any of the layers)—making the coordinates of the coloration in the layers obfuscated. Thus, the lock and unlock coordinates and coloration in multiple layers could require a match between the expected information from the decision tree AI engine with the information from the receiving AI engine. If the decision tree AI engine does not have the expected receiving AI engine's information, then it will not initialize the unlocking process to undo the multiple steganographic layers. Thus, leaving the protected information undetected.

The presence of multiple layers helps to protect the decision tree AI engine from having a pre-mature start. Several external “hard shell” layers could be present along the “outside” layers of the images, so that any color-coding relationships involved in the unlock process would not be detected. These layers would be determined, in part, based on a threat assessment. Because of different graphics capabilities across different devices, the sending AI engine would be involved in coordinating a series of choices relating to the sending and the receiving of information to the satellite AI engines. These choices would be coordinated with the receiving AI engine and the decision tree AI engine.

Limitations to the range of choices would initially be generated by the sender's AI engine in order to preserve the high degree of data protection. It is understood, that the system and method described herein would accomplish this in several ways, such as forbidding simple “passwords” to be introduced as authentication methods, and forbidding the use of the same lock and unlock sequence.

Flexibility of the system and method is also important to its wide-spread implementation. Therefore, the system and method will need to work with various sizes of files, different transport speeds, and different means of transport: wireless, wired, coaxial, telephone lines, fiber optics, and satellite communications, along with other methods that might be appropriate. Further, this technology could be used with HD, 3D, and holographic environments.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A method of digital steganography comprising the steps of:
providing a sending AI engine, wherein the sending AI engine is capable of being authenticated;
providing a receiving AI engine, wherein the receiving AI engine is capable of being authenticated;
initializing the sending AI engine upon authentication of a sender of data;
creating an initial armored security object containing data to be transferred securely, wherein the initial armored security object is created by the sending AI engine;
creating a decision tree AI engine, wherein the decision tree AI engine is created by the sending AI engine;
creating a final armored security object, wherein the final armored security object is created by the decision tree AI engine; and
comparing information received from a receiving AI engine with data known to represent the authenticated receiving AI engine to determine whether or not the data to be transferred securely should be unlocked, wherein the step of comparing information is conducted by the decision tree AI engine.

2. The method of digital steganography of claim 1, further comprising the step of notifying the sending AI engine that the data to be transferred securely was not rejected.

3. The method of digital steganography of claim 1, further comprising the step of notifying the sending AI engine that the data to be transferred securely was rejected.

4. The method of digital steganography of claim 3, further comprising the step of forming a returning AI engine, wherein the returning AI engine is formed from the decision tree AI engine.

5. The method of digital steganography of claim 4, wherein the returning AI engine comprises a self-destruct routine.

6. The method of digital steganography of claim 3, wherein the sending AI engine comprises a self-destruct routine.

7. The method of digital steganography of claim 3, further comprising the step of generating a summary log file.

8. The method of digital steganography of claim 1, wherein the initial armored security object is created after a threat assessment by the sending AI engine.

9. The method of digital steganography of claim 1, wherein the final armored security object is created after a threat assessment by the decision tree AI engine.

10. The method of digital steganography of claim 1, wherein the initial armored security object comprises a plurality of concentric layers.

11. The method of digital steganography of claim 1, wherein the final armored security object comprises a plurality of concentric layers, including at least one black outer layer.

12. The method of digital steganography of claim 10, wherein the plurality of concentric layers of the armored security object are each 3-dimensional.

13. The method of digital steganography of claim 10, wherein each of the concentric layers of the armored security object is the same shape.

14. The method of digital steganography of claim 10, wherein each of the concentric layers of the armored security object has at least one axis of rotation.

15. The method of digital steganography of claim 10, wherein each of the concentric layers of the armored security object has at least one surface.

16. The method of digital steganography of claim 1, further comprising the step of unlocking the armored security object.

17. The method of digital steganography of claim 16, wherein the armored security object is unlocked by the decision tree AI engine.

18. The method of digital steganography of claim 16 wherein step of unlocking the armored security object comprises manipulating each concentric layer of the armored security object in sequence from the outermost layer to the inner most layer.

19. The method of digital steganography of claim 18, wherein the manipulation of each concentric layer comprises actions selected from the group consisting of axis rotation, axis tilt, analysis of color, and analysis of texture.

20. A system of digital steganography comprising,
a sending AI engine;
a decision tree AI engine;
an armored security object; and
a receiving AI engine.

21. The system of digital steganography of claim 20, wherein the armored security object comprises a plurality of concentric layers.

22. The system of digital steganography of claim 21, wherein the plurality of concentric layers are 3-dimensional.

23. The system of digital steganography of claim 21, wherein each of the concentric layers is the same shape.

24. The system of digital steganography of claim 21, wherein each of the concentric, layers has at least one axis of rotation.

25. The system of digital steganography of claim 21, wherein each of the concentric layers is comprised of at least one surface.

26. The system of digital steganography of claim 25, wherein the at least one surface is comprised of a plurality of pixels.

27. The system of digital steganography of claim 25, wherein the at least one surface is comprised of at least one texture.

28. The system of digital steganography of claim 26, wherein each pixel comprises a color.

29. An armored security object comprising a plurality of concentric layers.

30. The armored security object of claim 29, wherein the plurality of concentric layers are 3-dimensional.

31. The armored security object of claim 29, wherein each of the concentric layers is the same shape.

32. The armored security object of claim 29, wherein each of the concentric layers has at least one axis of rotation.

33. The armored security object of claim 29, wherein each of the concentric layers is comprised of at least one surface.

34. The armored security object of claim 33, wherein the at one surface is comprised of a plurality of pixels.

35. The armored security object of claim 33, wherein the at least one surface is comprised of at least one texture.

36. The armored security object of claim 34, wherein each pixel comprises a color.
